(19) United States
(12) Patent Application Publication
(10) Pub. No.: US 2026/0212655 A1
(43) Pub. Date: Jul. 23, 2026

(54) Methods and Systems for Improving Prediction Accuracy of AI Model

(71) Applicant: Siemens Aktiengesellschaft, München (DE)

(72) Inventors: Hai Feng Wang, Shanghai (CN); Wen Chao Zou, Shanghai (CN)

(73) Assignee: Siemens Aktiengesellschaft, München (DE)

(21) Appl. No.: 19/157,353

(22) PCT Filed: Feb. 22, 2023
(86) PCT No.: PCT/CN2023/077710

§ 371 Date: Aug. 16, 2025

(51) Int. Cl. G06V 10/776; G06V 10/774

(52) U.S. Cl. CPC G06V 10/776; G06V 10/774

(57) ABSTRACT

Acquiring a 3D model and a first group of rendering condition set; acquiring label information according to the 3D model; determining the first group of rendering condition set as a current group of rendering condition set; randomly determining combinations of a plurality of groups of rendering conditions from the current group of rendering condition set, and rendering same respectively to obtain corresponding 2D images, so as to form a first image data set; training the current AI model by means of the first image data set; evaluating a prediction performance of the trained current AI model to obtain a first accuracy; judging whether the first accuracy meets a preset condition; if not, changing at least one rendering condition in the current group of rendering condition set; returning back to the step of rendering to the step of judging until the first accuracy meets the preset condition.

### CROSS-REFERENCE TO RELATED APPLICATIONS

This application is a U.S. National Stage Application of International Application No. PCT/CN 2023/077710 filed Feb. 22, 2023, which designates the United States of America, the contents of which are hereby incorporated by reference in their entirety.

### TECHNICAL FIELD

The present disclosure relates to artificial intelligence (AI) models. Various embodiments of the teachings herein include systems and/or methods for improving the prediction accuracy of an AI model.

### BACKGROUND

In recent years, training artificial intelligence models by generating synthetic image data has attracted more and more attention during machine learning studies. This is because the preparation of real image data is time-consuming and error-prone, and corresponding objects such as a car, a person, or a table need to be manually marked. However, there is still a certain gap between the synthetic image data and real image data, thereby making it impossible to ensure the performance of trained AI models.

### SUMMARY

Teachings of the present application describe methods for improving the prediction accuracy of an AI model, an electronic device and a medium. Relevant conditions for improving the prediction accuracy of the AI model can be accurately and rapidly obtained.

For example, some embodiments of the teachings herein include a method for improving the prediction accuracy of an AI model which includes: acquiring a 3D model and a first group of rendering condition set, where the first group of rendering condition set includes a plurality of default rendering conditions and at least one default rendering condition in the plurality of default rendering conditions contains a first numerical interval; acquiring label information according to the 3D model; determining the first group of rendering condition set as a current group of rendering condition set; determining a first AI model as a current AI model; randomly determining combinations of a plurality of groups of rendering conditions from the current group of rendering condition set, and rendering Same respectively to obtain corresponding 2D images, so as to form a first image data set, where each 2D image in the first image data set contains corresponding label information; training the current AI model by means of the first image data set; evaluating a prediction performance of the trained current AI model to obtain a first accuracy; judging whether the first accuracy meets a preset condition; when the first accuracy does not meet the preset condition, changing at least one rendering condition in the current group of rendering condition set to obtain an updated current group of rendering condition set; returning back to the step of rendering same respectively to obtain corresponding 2D images, the step of training, the step of evaluating, and the step of judging until the first accuracy meets the preset condition; and outputting a rendering condition set corresponding to the first accuracy meeting the preset condition, and corresponding trained AI model information.

As another example, some embodiments include an electronic device which includes: at least one memory, configured to store computer readable code; and at least one processor, configured to call the computer readable code to perform one or more of the methods described herein.

As another example, some embodiments include a computer readable medium storing computer readable instructions which, when executed, cause a processor to perform one or more of the methods described herein.

As another example, some embodiments include a computer program product including a computer program. When executed by a processor, the computer program performs one or more of the methods described herein.

### BRIEF DESCRIPTION OF THE DRAWINGS

The following accompanying drawings illustratively explain and interpret example embodiments of the present application, but do not limit the scope of the disclosure. In the drawings:

FIG. 1 is a flowchart of an example method for improving the prediction accuracy of an AI model incorporating teachings of the present disclosure; and

FIG. 2 is a schematic diagram of an example electronic apparatus incorporating teachings of the present disclosure.

### REFERENCE NUMERALS

100: method for improving the prediction accuracy of an AI model
110-172: method steps
200: electronic device 201: memory 202: processor

### DETAILED DESCRIPTION

The subject matter described herein will now be discussed with reference to exemplary implementations. These implementations are discussed only to enable those skilled in the art to better understand and implement the subject matter described herein, but do not limit the scope of protection set forth in the claims, applicability, or examples. The functions and arrangement of discussed elements can be changed, without departing from the scope of protection of the present disclosure. For each example, various processes or assemblies can be omitted, replaced, or added as needed. For example, the method described may be performed according to a sequence different from the sequence described, and each step may be added, omitted, or combined. Additionally, features described with respect to some examples may also be combined in other examples.

As used herein, the term “include” and its variations represent an open term, and mean “include but not limited to”. The term “based on” represents “based at least in part on”. The terms “one embodiment” and “an embodiment” represent “at least one embodiment”. The term “another embodiment” represents “at least one other embodiment”. The terms “first”, “second” and so on may refer to different or identical object. Other definitions, either clear or implicit, may also be included below. Unless otherwise indicated obviously from the context, the definition of one term is consistent throughout the specification.

The example embodiments are further described below in detail below with reference to the accompanying drawings.

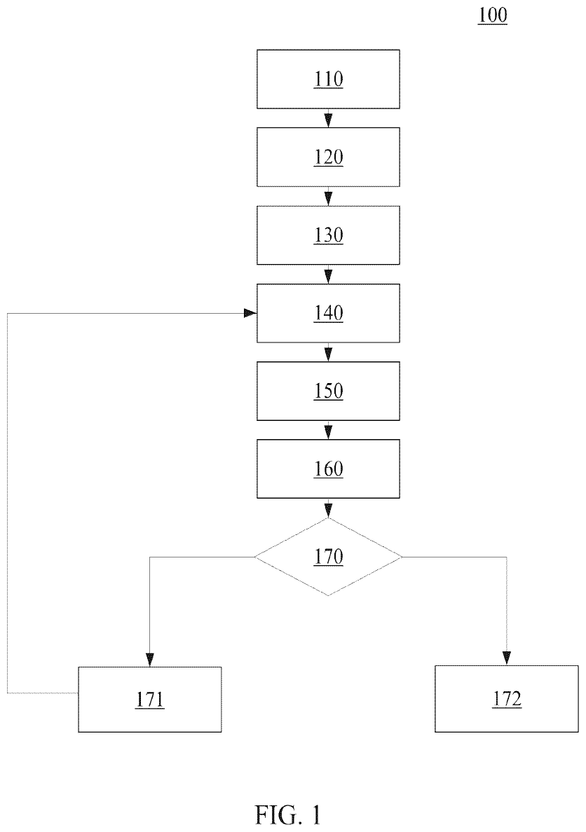

FIG. 1 is a flowchart of an example method for improving the prediction accuracy of an AI model incorporating teachings of the present disclosure. As shown in FIG. 1, the method 100 for improving the prediction accuracy of an AI model includes:

Step 110: A 3D model and a first group of rendering condition set are acquired. The first group of rendering condition set includes a plurality of default rendering conditions and at least one default rendering condition in the plurality of default rendering conditions contains a first numerical interval.

In some embodiments, at least one 3D model and the first group of rendering condition set may be acquired from a renderer. The first group of rendering condition set includes a type of a rendering engine, setting requirements of a camera, setting requirements of light, and setting requirements of a texture. Optionally, the first group of rendering condition set may also include: employing/or not employing image enhancement to obtain more image data, or specific means of the image enhancement, for example, rotation, scaling, random cropping, or adding noises.

Step 120: Label information is acquired according to the 3D model. In some embodiments, in a case that the AI model used in step 130 is an object detection model, then acquiring label information is specifically to acquire the label information of the at least one 3D model and/or at least one component in the at least one 3D model. For example, there is a scene where a car runs on a viaduct, in a case that the AI model is required to detect car wheels therein, the acquiring label information in step 120 is to acquire the label information of the car wheels in a relevant rendering scene. The label information includes a bounding box of car wheel and a label name corresponding to the car wheel.

In some embodiments, in a case that the AI model used in step 130 is a classification model, the acquiring label information is to acquire the label information of a scene itself containing the 3D model in the renderer. For example, there is a scene with a cat and/or a dog, in a case that the cat or the dog needs to be identified by using the AI model, the acquiring label information in step 120 is to acquire the label information of a relevant rendering scene itself. In this example, the label information is a label name corresponding to the cat or the dog.

Step 130: The first group of rendering condition set is determined as a current group of rendering condition set. A first AI model is determined as a current AI model.

Step 140: Combinations of a Plurality of Groups of Rendering conditions are randomly determined from the current group of rendering condition set, and same is rendered respectively to obtain corresponding 2D images, so as to form a first image data set. Each 2D image in the first image data set contains corresponding label information.

In some embodiments, N numerical values are randomly selected from a numerical interval of at least one rendering condition. The N numerical values are combined with other rendering conditions in the current group of rendering condition set, respectively, to determine the combinations of the plurality of groups of rendering conditions.

In Some Embodiments, it Is Assumed That the Current Group of rendering condition set includes three rendering conditions A, B, and C, where the rendering condition A: [0°, 10°], the rendering condition B: [texture 2], and the rendering condition C: [light source 1]. The randomly determining combinations of a plurality of groups of rendering conditions from the current group of rendering condition set refers to randomly selecting corresponding numerical values from the rendering conditions with the numerical intervals in the current group of rendering condition set, and combining same with the rendering conditions without the numerical intervals respectively, so as to determine the combinations of the plurality of groups of rendering conditions. For example: one of the combinations of the plurality of groups of rendering conditions may be: the rendering condition A: [0°]; the rendering condition B: [texture 2], and the rendering condition C: [light source 1]; one of the combinations of the plurality of groups of rendering conditions may be: the rendering condition A: [1], the rendering condition B: [texture 2], and the rendering condition C: [light source 1] , . . . , and one of the combinations of the plurality of groups of rendering conditions may be: the rendering condition A: [10°], the rendering condition B: [texture 2], and the rendering condition C: [light source 1].

Step 150: The current AI model is trained by means of the first image data set. In some embodiments, the first image data set is divided into a first training set, a first validation set, and a first testing set. The current AI model may be trained by means of the first training set and the first validation set.

Step 160: A prediction performance of the trained current AI model is evaluated to obtain a first accuracy. In some embodiments, the prediction performance of the trained current AI model is evaluated by means of the first testing set or a real image data set with the label information to obtain the first accuracy. Optionally, the prediction performance of the trained current AI model may be evaluated by means of a cloud AI evaluation module or a local server with strong computing performance.

In some embodiments, the prediction performance of the trained current AI model is evaluated by means of the first testing set or the real image data set with the label information to obtain an accuracy at a first stage. The trained current AI model is deployed to an edge device. The prediction performance of the trained current AI model is monitored on the edge device to obtain an accuracy at a second stage. Both the accuracy at the first stage and the accuracy at the second stage are taken as the first accuracy, that is, the first accuracy may include data at two stages.

In some embodiments, the trained current AI model is deployed to the edge device. The prediction performance of the trained current AI model is monitored to obtain the first accuracy. In some embodiments, the prediction performance of the trained current AI model is monitored by means of a machine vision system or a sensor or artificially. For example, it is assumed that the current AI model is to predict whether there is an object in a certain position, a sensor such as a radar or a distance measurement sensor may assist in determining whether there is an object in a relevant position, which is predicted by means of the current AI model, so as to evaluate whether the prediction of the current AI model is accurate.

In some embodiments, after the first accuracy is obtained, the current group of rendering condition set corresponding to the first accuracy and corresponding trained AI model information are inputted into a knowledge graph. In some embodiments, cases with relatively low accuracy therein may also be inputted into the knowledge graph, with the purpose of being ready for further data analysis and capable of retraining the AI model.

Step 170: Whether the first accuracy meets a preset condition is judged. In a case that the first accuracy does not meet the preset condition, step 171 is performed to change at least one rendering condition in the current group of rendering condition set to obtain an updated current group of rendering condition set. The method returns back to perform step 140 to step 170 until the first accuracy meets the preset condition.

Specifically, the at least one rendering condition in the current group of rendering condition set is changed within a preset range corresponding to each rendering condition in the current group of rendering condition set. In some embodiments, it may be randomly changed or may be manually changed by a user.

In some embodiments, it is assumed that each rendering condition in the current group of rendering condition set includes A, B, and C, the preset range of the rendering condition A is [0°, 100°], the preset range of the rendering condition B is [texture 1,texture 2, texture 3], and the preset range of the rendering condition C is [light source 1, light source 2]. It is assumed that the first group of rendering condition set includes: the rendering condition A: [0°, 10°], the rendering condition B: [texture 2], and the rendering condition C: [light source 1], the updated current group of rendering condition set, for example: the rendering condition A: [20°, 30°], the rendering condition B: [texture 2], and the rendering condition C: [light source 1], may be obtained by changing at least one rendering condition on the basis of the first group of rendering condition set within the preset range of each rendering condition.

Step 172: A rendering condition set corresponding to the first accuracy meeting the preset condition, and corresponding trained AI model information are outputted.

In some embodiments, the until the first accuracy meets the preset condition refers to until the first accuracy meets a highest accuracy within a preset number of cycles.

In some embodiments, after step 172, a second AI model is determined as the current AI model. The method returns back to perform step 140 to step 170 until the second accuracy meets the highest accuracy within the preset number of cycles. When K AI models are preset, the highest accuracy corresponding to each AI model is obtained, respectively. The rendering condition set corresponding to the highest accuracy and the corresponding trained AI model information are selected from all the accuracies corresponding to the K AI models for outputting.

In some embodiments, the AI model information may include an AI model name, hyper-parameters, and the like.

The teachings of the present disclosure may be used to continuously improve the quality of a synthetic image data set through result orientation, specifically, continuously evaluate the prediction performance of the AI model after the synthetic image data set generated under different rendering conditions is trained on the AI model, and obtain the trained model information of the relevant AI model, so as to accurately and quickly obtain corresponding conditions for improving the prediction accuracy of the AI model.

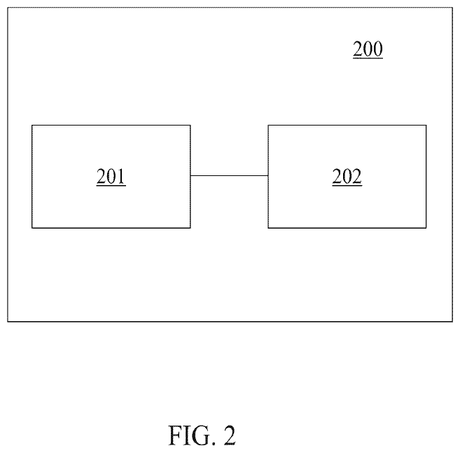

FIG. 2 is a schematic diagram of a device control platform 200 incorporating teachings of the present disclosure. As shown in FIG. 2, the device control platform 200 includes a processor 201 and a memory 202. Instructions are stored in the memory 202. When executed by the processor 201, the instructions implement the method 100 as described above.

The at least one processor 201 may include a microprocessor, an application specific integrated circuit (ASIC), a digital signal processor (DSP), a central processing unit (CPU), a graphics processing unit (GPU), a state machine, and the like. Embodiments of the computer readable medium include, but are not limited to, a floppy disk, a CD-ROM, a magnetic disk, a memory chip, a ROM, an RAM, an ASIC, a configured processor, an all-optical medium, all magnetic tapes or other magnetic media, or any other media capable of reading instructions from a computer processor. In addition, various other forms of computer readable media may send instructions to a computer or carry the instructions, and include a router, a private or public network, or other wired and wireless transmission devices or channels. The instructions may include codes of any computer programming language, including C, C++, C language, Visual Basic, Java and JavaScript.

Computer readable instructions may be stored on a computer readable medium, and when executed, the computer readable instructions cause the processor to perform one or more of the foregoing methods for improving the prediction accuracy of an AI model. The embodiments of the computer readable medium include a floppy disk, a hard disk, a magneto-optical disk, an optical disk (such as a CD-ROM, a CD-R, a CD-RW, a DVD-ROM, a DVD-RAM, a DVD-RW, a DVD+RW), a magnetic tape, a non-volatile storage card, and a ROM. Optionally, the computer readable instructions may be downloaded from a server computer or a cloud via a communication network.

It should be noted that not all steps and modules in all flows and all system structure diagrams described above are necessary, and certain steps or modules may be neglected according to actual requirements. The sequence of performing each step is not permanent, and may be adjusted according to requirements. System structures described in all the embodiments described above may be physical structures and may also be logical structures. That is, some modules may be implemented by the same physical entity. Alternatively, some modules may be implemented by a plurality of physical entities. Alternatively, some modules may be commonly implemented by some components in a plurality of independent devices. Some methods include: acquiring a 3D model and a first group of rendering condition set; acquiring label information according to the 3D model; determining the first group of rendering condition set as a current group of rendering condition set; randomly determining combinations of a plurality of groups of rendering conditions from the current group of rendering condition set, and rendering same respectively to obtain corresponding 2D images, so as to form a first image data set; training the current AI model by means of the first image data set; evaluating a prediction performance of the trained current AI model to obtain a first accuracy; judging whether the first accuracy meets a preset condition; if not, changing at least one rendering condition in the current group of rendering condition set; returning back to the step of rendering to the step of judging until the first accuracy meets the preset condition.

What is claimed is:

1. A method for improving the prediction accuracy of an AI model, the method comprising:
acquiring a 3D model and a first set of rendering conditions including a plurality of default rendering conditions, wherein at least one of the default rendering conditions contains a first numerical interval;
acquiring label information according to the 3D model;
identifying the first group of rendering conditions as a current group of rendering conditions set and a first AI model as a current AI model;
randomly determining combinations of a plurality of groups of rendering conditions from the current group of rendering conditions, and rendering same respectively to obtain corresponding 2D images to form a first image data set, wherein each 2D image in the first image data set contains corresponding label information;
training the current AI model with the first image data set;
evaluating a prediction performance of the trained current AI model to obtain a first accuracy;
judging whether the first accuracy meets a preset condition;
if the first accuracy does not meet the preset condition, changing a rendering condition in the current group of rendering conditions to obtain an updated current group of rendering
conditions and repeating the determining combinations ; training, and evaluating until the first accuracy meets the preset condition; and
if the first accuracy meets the preset condition, declaring a rendering condition set and corresponding trained AI model information.

2. The method according to claim 1, wherein training the current AI model comprises:
dividing the first image data set into a first training set, a first validation set, and a first testing set; and
training the current AI model using the first training set and the first validation set.

3. The method according to claim 2, wherein evaluating a prediction performance of the trained current AI model to obtain a first accuracy comprises
evaluating the prediction performance of the trained current AI model using the first testing set or a real image data set with the label information to obtain the first accuracy.

4. The method according to claim 2, wherein evaluating a prediction performance of the trained current AI model to obtain a first accuracy comprises:
evaluating the prediction performance of the trained current AI model using the first testing set or the real image data set with the label information to obtain an accuracy at a first stage;
deploying the trained current AI model to an edge device;
monitoring the prediction performance of the trained current AI model on the edge device to obtain an accuracy at a second stage; and
taking both the accuracy at the first stage and the accuracy at the second stage as the first accuracy.

5. The method according to claim 1, wherein evaluating a prediction performance of the trained current AI model to obtain a first accuracy comprises:
deploying the trained current AI model to an edge device; and
monitoring the prediction performance of the trained current AI model to obtain the first accuracy.

6. The method according to claim 5, wherein monitoring the prediction performance of the trained current AI model comprises
monitoring the prediction performance of the trained current AI model using a machine vision system or a sensor or artificially.

7. The method according to claim 1, wherein after the first accuracy is obtained, the method further comprises:
combining the current group of rendering conditions corresponding to the first accuracy and corresponding trained AI model information into a knowledge graph.

8. The method according to claim 1, wherein randomly determining combinations of a plurality of groups of rendering conditions from the current group of rendering condition set comprises:
randomly selecting N numerical values from a numerical interval of at least one rendering condition; and
combining the N numerical values with other rendering conditions in the current group of rendering conditions, respectively, to determine the combinations of the plurality of groups of rendering conditions.

9. The method according to claim 1, wherein the first group of rendering condition set comprises:
a type of a rendering engine, setting requirements of a camera, setting requirements of light, and setting requirements of a texture.

10. The method according to claim 1, wherein changing a rendering condition in the current group of rendering condition set comprises
changing at least one rendering condition in the current group of rendering condition within a preset range corresponding to each rendering condition in the current group of rendering conditions.

11. The method according to claim 1, wherein the first accuracy meets the preset condition comprises:
the first accuracy meets a highest accuracy within a preset number of cycles;
after the outputting a rendering condition set corresponding to the first accuracy meeting the preset condition, and corresponding trained AI model information, the method further comprises:
determining a second AI model as a current AI model; and
repeating the elements until the second accuracy meets the highest accuracy within the preset number of cycles;
when K AI models are preset, obtaining the highest accuracy corresponding to each of the AI models, respectively; and
selecting a rendering condition set corresponding to the highest accuracy and the corresponding trained AI model information from all the accuracies corresponding to the K AI models for outputting.

12. The method according to claim 1, wherein the AI model information comprises: an AI model name and hyper-parameters.

13. An electronic device, comprising:
a processor;
a memory storing executable instructions;
wherein the processor is configured to read the instructions from the memory and execute the instructions to:
acquire a 3D model and a first set of rendering conditions including a plurality of default rendering conditions, wherein at least one of the default rendering conditions contains a first numerical interval;
acquire label information according to the 3D model;
identify the first group of rendering conditions current group of rendering conditions set and a first AI model as a current AI model;
randomly determine combinations of a plurality of groups of rendering conditions from the current group of rendering conditions, and rendering same respectively to obtain corresponding 2D images to form a first image data set, wherein each 2D image in the first image data set contains corresponding label information;
train the current AI model with the first image data set;
evaluate a prediction performance of the trained current AI model to obtain a first accuracy;
judge whether the first accuracy meets a preset condition;
if the first accuracy does not meet the preset condition, change a rendering condition in the current group of rendering conditions to obtain an updated current group of rendering conditions and repeat by determining combinations, training, and evaluating until the first accuracy meets the preset condition; and
if the first accuracy meets the preset condition, declare a rendering condition set and corresponding trained Al model information.

14-15. (canceled)
